(19) United States
(12) Patent Application Publication
(10) Pub. No.: US 2010/0081049 A1
(43) Pub. Date: Apr. 1, 2010

(54) Electrochemical Element

(75) Inventors: Konrad Holl, Aalen-Dewangen (DE); Martin Krebs, Rosenberg (DE); Hartmut Weidenbacher, Adelmannsfelden (DE); Bernd Kreidler, Ellwangen (DE); Hermann Löffelmann, Ellwangen (DE); Dejan Ilic, Ellwangen (DE); Magnus Berggren, Vreta Kloster (SE); Staffan Nordlinder, Linkoping (SE); Linda Andersson, Linkoping (SE); Lars-Olof Hennerdal, Orebro (SE); Anurak Sawatdee, Linkoping (SE)

Correspondence Address: IP GROUP OF DLA PIPER LLP (US), ONE LIBERTY PLACE, 1650 MARKET ST, SUITE 4900, PHILADELPHIA, PA, 19103, US

(73) Assignees: VARTA MICROBATTERY GMBH, Hannover (DE); ACREO AB, Kista (SE)

(21) Appl. No.: 11/887,686

(22) PCT Filed: Apr. 6, 2006
(86) PCT No.: PCT/EP2006/003132

§ 371 Date: Aug. 4, 2009

(30) Foreign Application Priority Data
Apr. 8, 2005 (DE) 10 2005 017 682.8

(51) Int. Cl. H01M 6/46; H01M 6/40; H01M 6/00

(52) U.S. Cl. 429/162; 29/623.5

(57) ABSTRACT

A battery having at least one positive and at least one negative electrode arranged alongside one another on a flat, electrically nonconductive substrate and connected to one another via an electrolyte which conducts ions.

### RELATED APPLICATION

This is a §371 of International Application No. PCT/EP2006/003132, with an international filing date of Apr. 6, 2006 (WO 2006/105966 A1, published Oct. 12, 2006), which is based on German Patent Application No. 10 2005 017 682.8, filed Apr. 8, 2005.

### TECHNICAL FIELD

This disclosure relates to an electrochemical element having at least one positive and at least one negative electrode, batteries containing such an element and to a method for production of such an electrochemical element.

### BACKGROUND

Electrochemical elements and batteries are known in widely differing embodiments. These also include so-called printed batteries, in which functional parts, in particular electrodes and conductor tracks are printed on an appropriate substrate.

In conventional printed batteries, the output conductors are located on various levels. There are two collector levels, two electrode levels and one separator level. A battery such as this is described in U.S. Pat. No. 4,119,770. A cell is formed as a stack of different components, with the electrical output conductors being located on the upper face and lower face of the cell. A plurality of cells are stacked to form a battery. In this case, the negative pole of the lower cell is automatically connected to the positive pole of the upper cell.

U.S. Pat. No. 4,195,121 describes flexible electrodes. The electrodes are composed of the active material, a conductivity material and an organic binding agent. Ethylene-acrylic acid is proposed as the binding agent.

Another cell is described in JP 60155866. This comprises in each case one output conductor with a laminated-on anode and cathode. An electrolyte in the form of a gel is located in a fiber felt between them. The thickening agent is hydroxyethylcellulose.

U.S. Pat. No. 4,623,598 describes a contact apparatus for flat batteries. The housing film is composed of a conductive layer which is split in two, and an isolation layer located on the outside. One part or the other of the conductive layer is connected through two windows in the isolation layer. This housing film is mounted around the electrode stack such that one part of the conductive film makes contact with the anode and the other with the cathode.

U.S. Pat. No. 5,652,043 describes an open cell with an aqueous electrolyte. An electrolyte is located between the electrodes, and is composed of a hygroscopic material, a substance which conducts ions and a water-soluble polymer which holds the electrodes together by an adhesive effect. The cell does not dry out in normal climatic conditions. Furthermore, any gas which may be created can be emitted to the surrounding area thus preventing swelling of the cell.

U.S. Pat. No. 5,897,522 describes the use of the flat cell described in U.S. Pat. No. 5,652,043 in various thin appliances such as timers, infusers, thermometers, glucose sensors and an electronic game. A further improvement to the flat battery is described in WO 0062365. In this case, a chip which is implemented in the battery or on the battery improves the functionality. This compensates for voltage fluctuations across a DC/DC converter.

All the designs mentioned have the traditional stack structure, in which the functional layers, in general five of them, are arranged one above the other.

It could therefore be advantageous to provide a battery which is as thin and flat as possible, and has a design which is as simple as possible. It could also be advantageous to manufacture the corresponding battery as easily as possible.

### SUMMARY

We provide a battery having at least one positive and at least one negative electrode arranged alongside one another on a flat, electrically non-conductive substrate and connected to one another via an electrolyte which conducts ions.

We also provide a method of producing an electrochemical element, wherein the electrodes are applied to an endless strip which is used as the substrate and provided continuously with output conductors.

We further provide the method of producing the electrochemical element, wherein the electrodes are printed on.

### BRIEF DESCRIPTION OF THE DRAWINGS

Further features will become evident from the drawings and from the following description of preferred structures. The individual features can each be implemented in their own right or in the form of a combination of two or more of them with one another. The described particular structures are intended to be used only for explanatory purposes and to assist understanding the disclosure, and should in no way be considered restrictive. The drawings described in the following text are also a part of the present description with this being made clear by express reference.

In the drawings:

FIG. 1 shows the schematic design of an electrochemical element as an individual cell with electrodes located alongside one another;

FIG. 2 shows the schematic design of an electrochemical element with three individual cells;

FIG. 3 shows the schematic design of an electrochemical element with four individual cells (connected in series and in parallel), and

FIG. 4 shows a schematic detail of the production process for forming individual cells on an endless strip which is used as a substrate.

### DETAILED DESCRIPTION

In our electrochemical element the at least one positive and at least one negative electrode are arranged alongside one another on a flat, electrically non-conductive substrate and are connected to one another via an electrolyte which can conduct ions. The flat substrate is preferably a film, with the use of a plastic film also being preferred.

The arrangement of the positive and negative electrode alongside one another results in the functional parts of the electrochemical element being arranged essentially in three levels one above the other. These are the flat, electrically non-conductive substrate, the electrodes arranged on the substrate and the electrolyte which conducts ions and connects the two electrodes to one another, and in this case at least partially covers them. This results in a thin electrochemical element design, which is very flat overall. In this analysis, the level of the electrodes is regarded as a plane or substantially planar wherein the electrodes can themselves, of course, be formed from different parts, for example, from the corresponding output conductors/collectors as well as the active electrode material. This will be explained in more detail in the following text.

The positive and negative electrodes can generally be arranged on only one side of the flat substrate, as is likewise also described in the following text. However, it is likewise possible to arrange positive and negative electrodes on both sides of the flat substrate to achieve corresponding different configurations of an electrochemical element. However, the critical factor is that the positive and negative electrodes are arranged alongside one another (and not on different levels one above the other).

In one development, the electrochemical element has conductor tracks which are used as output conductors/collectors and are preferably and sensibly arranged between the flat substrate and the actual electrodes, or the (electrochemically) active electrode material. These conductor tracks may be provided in various ways. For example, on the one hand, it is possible and preferable to use electrically conductive films, in particular metal films, as conductor tracks such as these. On the other hand, the conductor tracks may preferably be thin metal layers, which can be applied to the substrate by a conventional metalization process. Finally, one particularly preferred variant that should be emphasized is for the conductor tracks to be applied to the substrate as a paste which can be printed. These pastes may also be conventional so-called “conductive adhesives.” In preferred aspects of the electrochemical element, the electrodes and the electrode material itself are applied to the substrate as paste which can be printed. This allows the already described advantages to be achieved particularly well. Appropriate pastes can be applied to appropriate substrates comparatively easily using standard processes, to be precise, in fact, also in the form of thin films as is preferable.

The positive and negative electrodes are arranged on one level, but physically separated from one another. The electrical connection between the positive and the negative electrode is made exclusively via the electrolyte, which can conduct ions. In the case of this arrangement, it is essential on the one hand that the positive and the negative electrodes do not touch. On the other hand, it is expedient to choose the distance between the two electrodes not to be excessive to ensure a design which saves as much space as possible. Accordingly, it is preferable if the at least one positive electrode and the at least one negative electrode are arranged on the substrate at a distance of about 1 μm to about 10 mm from one another. Within this range, distances between about 100 μm and about 1 mm are preferable.

It is likewise preferable to use a gel-like electrolyte as the electrolyte which can conduct ions. Electrolytes such as these make it possible to achieve flat configurations, in particular thin flat configurations, particularly easily. It is also preferable for the electrolyte to be fixed or stabilized in a felt to make the gel-like electrolyte more mechanically robust. The electrolyte may preferably be in the form of a layer, in particular, a thin film. This layer is arranged such that it ensures the necessary conductivity between the positive electrode and the negative electrode. In this case, the electrolyte generally at least partially covers the electrodes in situations such as these to provide adequate conductivity. It is also preferable for the electrolyte or the electrolyte layer to completely cover the positive and the negative electrodes or, in particular, even to project beyond the corresponding electrode areas. Arrangements of the electrolyte layer such as these can also be produced more easily.

A further plastic film can be provided which (on the basis of the layer structure comprising three levels as mentioned initially) is arranged above the electrolyte level and, accordingly, at least partially covers the electrolyte and/or the electrodes. In this case, as well, it is preferable for the electrolyte and the electrodes to be covered completely. This further plastic film on the one hand has a protective function for the electrolyte/electrodes to protect them against mechanical damage or against the ingress of undesirable substances or weather influences. On the other hand, the further plastic film makes the electrochemical element more mechanically robust overall. A further plastic film is also preferable for the plastic film, together with the substrate, to form a type of housing which surrounds the electrolyte and the electrodes, forming a seal. This will be explained in more detail in conjunction with the figures. As an alternative to the further plastic film, it is also possible to provide appropriate protection and/or appropriate robustness in a different manner, for example, by applying a film or a corresponding layer over the electrolyte level, preferably by printing. In general, this layer is likewise composed of plastic, that is to say it is at least polymer-based.

One particularly preferred aspect of the electrochemical element is provided by arranging a plurality, in particular, a multiplicity of positive and negative electrodes on the flat, electrically non-conductive substrate. This arrangement is sensibly produced, in particular, in pairs, that is to say in each case one positive and in each case one negative electrode are arranged in pairs alongside one another. This makes it possible to connect a plurality or a large number of individual cells (with a positive and a negative electrode) to one another. This aspect will also be explained in more detail layer, in conjunction with the figures.

The substrate may in particular have conductor tracks via which the electrodes (that is to say the plurality or multiplicity of electrodes) which are arranged on the substrate are connected in series and/or in parallel. With regard to the application of these conductor tracks, reference can be made to the above description in conjunction with the output conductors/collectors.

The method for production of an electrochemical element, as has been described above, is characterized in that the electrodes, or the functional parts which form the electrodes, are applied to an endless strip which is used as a substrate. This allows a multiplicity of individual cells to be produced, each having one positive and one negative electrode, in which case, if required appropriate conductor tracks can be integrated in the method, for connection of these individual cells (in series or in parallel). The endless strip may already be provided with the output conductors/collectors of the electrodes, thus considerably simplifying the method procedure overall. Furthermore, it is particularly preferable for the electrodes to be applied in the form of a paste, in particular, a paste in the form of a print to the substrate or to the corresponding output conductors, preferably by being printed on.

If the electrochemical element is in the form of an individual cell, this results in the advantage of a considerably thinner design which is less complicated overall since the number of levels in which functional components are arranged can be reduced. The electrical contacts are located on one level so that there is no need for complex through-plating between different levels, in particular, between levels which are well separated from one another. Furthermore, we make it possible to connect a plurality or a large number of individual cells to one another in a simple manner. It is possible to arrange even a plurality or a large number of electrodes in pairs on the flat, electrically non-conductive substrate, and at this stage to provide appropriate conductor tracks for connection with individual cells on this substrate. It is also possible to mount completely finished individual cells on a further carrier film, which already has the conductor tracks required for connection of individual cells, and to connect them to one another via appropriate contact-making means. Normal adhesives can be used for attachment purposes and a conventional conductive adhesive or conductive varnish is typically used to make contact, for example, an appropriate conductive adhesive containing silver. Once the entire battery comprising the plurality or large number of individual cells has been completed, this can finally be covered with a (further) covering film. By way of example, this can be adhesively bonded or laminated on. As a consequence, a battery such as this (as in the case of the already described further plastic film) is made mechanically robust and protected against external influences, for example, weather influences. The electrical contacts of the battery are passed out on the carrier film and can be tapped off mechanically, or likewise by means of a conductive adhesive.

The electrochemical elements are particularly thin, and, if required, also particularly flexible, both in the form of an individual cell and in the form of batteries formed from a plurality or large number of individual cells, in comparison to electrochemical elements according to the prior art. The electrochemical element can therefore be used particularly well for those applications in which thinness and, possibly, high flexibility are desirable, that is to say, for example, for so-called “smart cards” or “smart tags.”

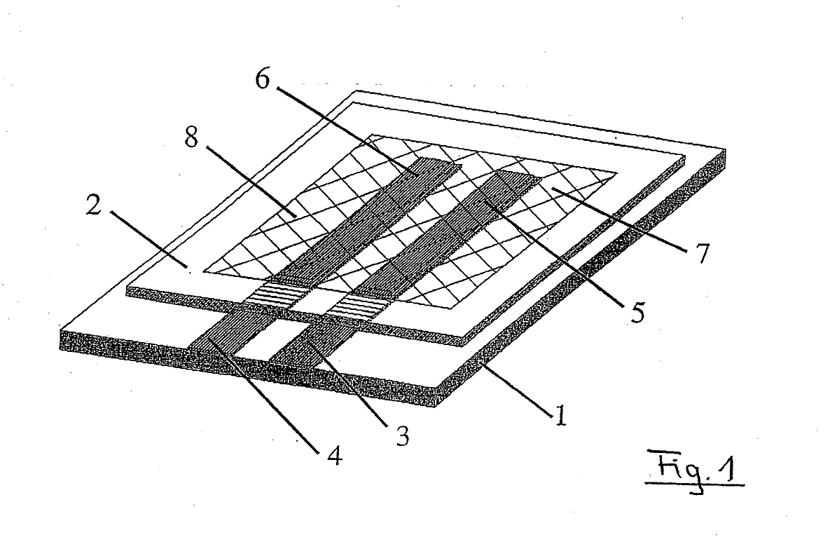

FIG. 1 shows an electrochemical element in the form of a so-called individual cell. In this case, so-called collectors/output conductors 3, 4 are applied to a flat substrate 1 in the form of an electrically non-conductive, thin plastic film 2. These were applied to the substrate 1 in the form of electrically conductive pastes (preferably silver, copper, nickel, aluminum, indium, bismuth or graphite), and then dried. Pastes such as these may normally contain binding agents in the form of polymers which, for example, can be thermally or chemically solidified.

As already explained initially, application of the collectors/output conductors 3, 4 is not restricted to application of electrically conductive pastes. The collectors/output conductors 3, 4 may in a comparable manner comprise thin electrically conductive films (metal films, plastic films filled with conductive materials). These films are preferably connected to the substrate 1 by cold or hot adhesive bonding. Furthermore, the collectors/output conductors 3, 4 can also be produced using conventional metalization processes (vacuum deposition, sputtering, electrochemical deposition and the like).

The cathode 5 (that is to say the corresponding electrode material) is applied to the collector 3, as shown in FIG. 1. This application process is preferably carried out using a paste which can be printed. However, it is also possible to apply a separately produced cathode film. The anode 6 (that is to say the corresponding electrode material) is applied to the collector 4. Both the cathode 5 and the anode 6 make electrical contact with the collectors/output conductors 3, 4. In this case, with an appropriate overall design of the electrochemical element, it may be sufficient for them just to rest on loosely. A firm connection can also be provided between the collectors/output conductors 3, 4 and the electrodes 5, 6.

A gel-like electrolyte 7 is located above the electrodes (cathode 5 with the output conductor 3; anode 6 with the output conductor 4) and is fixed by a network structure or a felt 8. In this case, the electrolyte 7 with the felt 8 covers the active electrode material of the cathode 5 and of the anode 6.

A further plastic film 2 is located above the electrolyte 7 with felt 8, on the one hand completely covering the electrolyte 7, and on the other hand also projecting beyond the dimensions of the electrolyte 7. In this way, the substrate 1 and the plastic film 2 form a housing which is closed, thereby forming a seal for the functional components located between the substrate 1 and the plastic film 2, specifically the actual electrodes (5, 3; 6, 4).

FIG. 1 shows the improved thin design of the electrochemical element. The actual design includes only three levels (arranged one above the other), specifically the level of the substrate 1, the level of the electrodes (cathode 5 with the output conductor 3, anode 6 with the output conductor 4, arranged alongside one another) and the level of the electrolyte above the level of the electrodes. FIG. 1 shows a structure with four levels in which the further plastic film 2 above the level of the electrolyte also forms a natural level and, together with the substrate 1, forms the housing, which is closed forming a seal, for the actual two levels with the functional components.

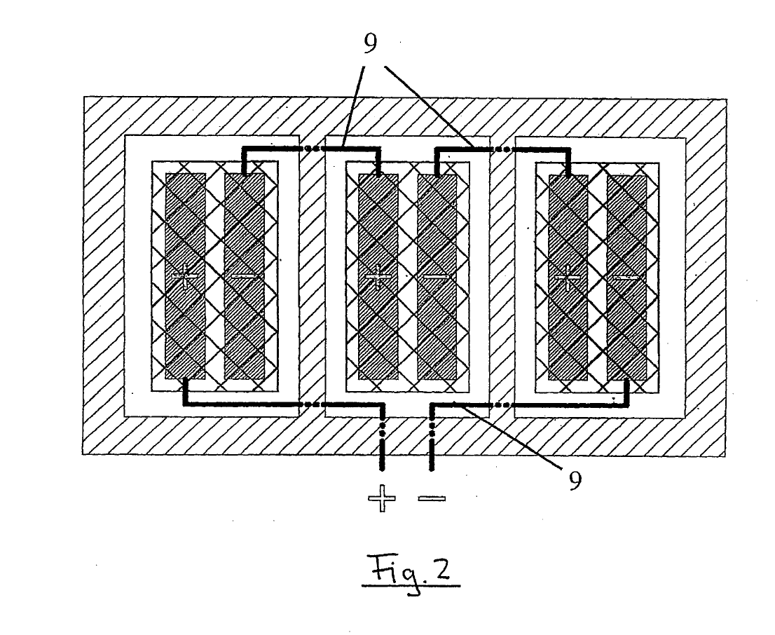

FIG. 2 shows the schematic design of an electrochemical element (battery) in which three individual cells with electrodes located alongside one another in pairs (that is to say three individual cells as shown in FIG. 1) are connected to one another via electrically conductive tracks (conductor tracks 9). This allows higher voltages to be used. Series connections such as these can lead to electrochemical elements with voltages of 30 V or more which can be produced particularly easily and at particularly low cost.

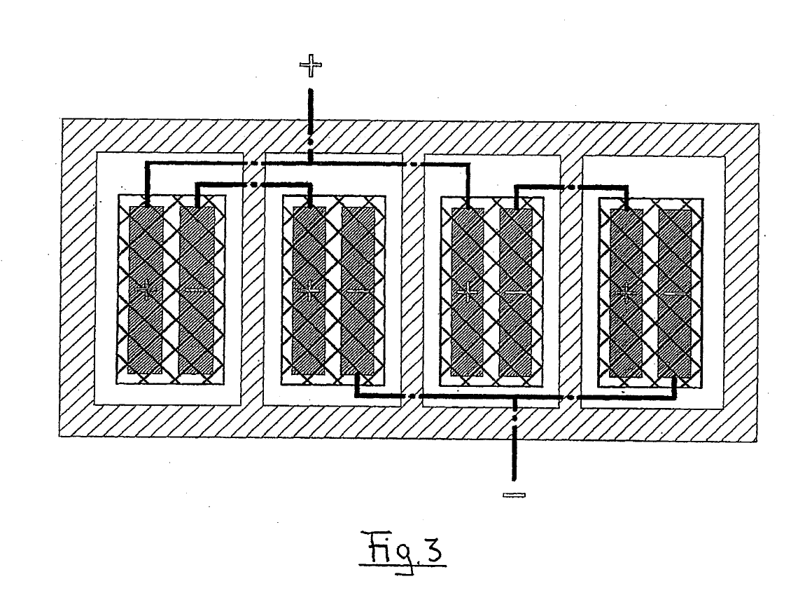

FIG. 3 shows the schematic design of an electrochemical element (battery) with four individual cells (see FIG. 1) with electrodes located alongside one another in pairs. In this case, these four individual cells are connected both in series and in parallel. This design allows different overall voltages and capacities, as well as load capabilities to be achieved.

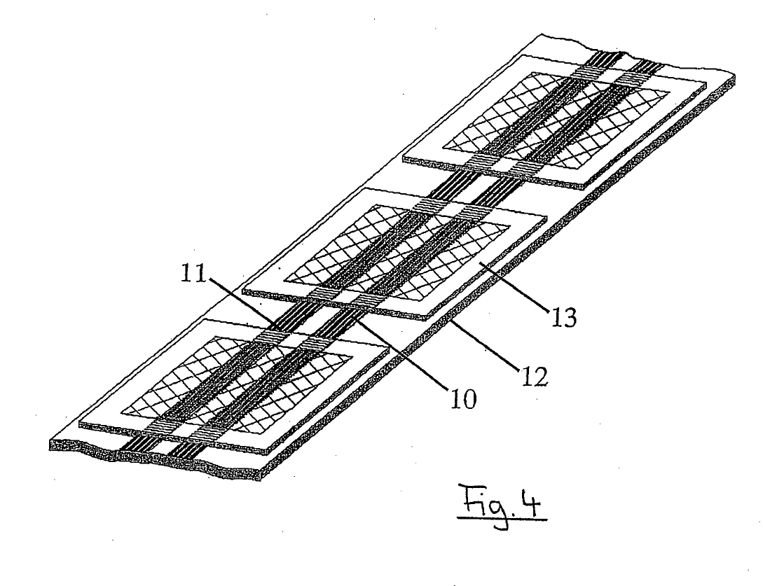

FIG. 4 shows, schematically, a detail from the production process. In this case, the electrochemical elements can be produced endlessly in one row (as illustrated) or else in a plurality of rows (as not illustrated) on a substrate 12 (carrier strip) in the form of an endless strip. The conductor tracks 10 and 11 which are used as collectors/output conductors are applied to the substrate 12 even before the actual process of producing the individual cells. Then (as described in conjunction with FIG. 1) the actual electrodes or the corresponding electrode material are applied to the conductor tracks 10 and 11 at the points intended for this purpose. The electrolyte is then applied and is stabilized as a gel-like electrolyte by means of a felt. On the basis of the information relating to FIG. 1, the actual electrodes and the electrolyte are not provided with reference symbols in FIG. 4. Finally, a further plastic film in the form of a covering film 13 is applied over the electrolyte and then closes the respective individual cell on the substrate 12, together with this, in the form of a housing. Finally, the individual cells can be separated again, if required, or else can be passed on to a plurality of further processing steps.

In this context it should also be mentioned that, as shown in FIG. 4 and, apart from this, in an entirely general form, both the substrate 12 and the covering film 13 may be produced from self-adhesive films. On the one hand this makes it easier to apply the covering film to the respective completed individual cell. On the other hand, if required after separation of the individual cells produced, the substrate 12 can be mounted directly by adhesive bonding, for example, on a printed circuit board, without any additional adhesive.

### Example

To produce a 1.5 V battery system, the following procedure is adopted to produce an electrochemical element as illustrated in FIG. 1. This results in a zinc-carbon system. This system will be mentioned merely by way of example, but is characterized by comparatively low costs.

First, appropriate films are produced for the substrate and for the further plastic film that is used as a covering film. In this case, plastic films with a low gas and water-vapor diffusion rate are preferable, that is to say in particular composed of PET, PP or PE. If the intention is for these films subsequently to be hot-sealed to one another, the basic films that are produced can be coated with a further low-melting point material. By way of example, this may be a fusion adhesive composed of a copolymer based on PE.

To produce the negative electrode (anode) a collector is first printed onto the substrate in the form of a conductive adhesive (based on silver, copper or graphite). Conductive adhesives based on silver, nickel or graphite may be quoted as collector/output conductor materials for the positive electrode (cathode) and are likewise printed on.

If the aim is to produce particularly thin collectors/output conductors, then vacuum coating can also be used. In this case, copper for the anode and nickel for the cathode are vapordeposited in a hard vacuum as the collector/output conductor.

The electrode material for the anode is then printed onto the appropriate collector/output conductor. A screen-printing process is preferably used to do this. The electrode material is a zinc paste comprising zinc powder, a suitable binding agent and a suitable solvent. A paste for printing the cathode material on the other collector/output conductor is also used in a corresponding manner. This cathode material may be composed of manganese dioxide (MnO₂), carbon black and/or graphite as a conductive material, together with a suitable binding agent and a suitable solvent. Once again this is preferably done by screen-printing.

Finally, the electrolyte may be applied in a further method step. The electrolyte is preferably a gel-like paste, composed, for example, of an aqueous solution of zinc chloride, in which case this solution may be entirely or partially dried in advance. The electrolyte is likewise preferably applied by a printing process. The electrolyte (as illustrated in FIG. 1) preferably covers the complete surface of both electrodes. As is likewise illustrated in FIG. 1, the electrolyte can be reinforced and stabilized by a felt-like or mesh-like material.

The individual cell produced is then covered, according to the example, with the aid of the second (further) plastic film, that is to say it is sealed in the form of a housing. This is preferably done with the aid of a hot-sealing process. As discussed in conjunction with FIG. 4 it is equally possible to use preferably self-adhesive films for the substrate and for the further plastic film. This also allows particularly simple application of the individual cell or of the battery formed from a plurality of individual cells to the corresponding base body of the unit to be supplied with electrical current.

1-17. (canceled)

18. A battery having at least one positive and at least one negative electrode arranged alongside one another on a flat, electrically non-conductive substrate and connected to one another via an electrolyte which conducts ions.

19. The battery of claim 18, wherein the flat substrate is a plastic film.

20. The battery of claim 18, further comprising conductor tracks which are output conductors and are arranged between the substrate and the electrodes.

21. The battery of claim 20, wherein the conductor tracks are metal films.

22. The battery of claim 20, wherein the conductor tracks are thin metal layers applied to the substrate by metallization.

23. The battery of claim 20, wherein the conductor tracks are applied to the substrate as printable paste.

24. The battery of claim 18, wherein the electrodes are applied to the substrate as printable paste.

25. The battery of claim 18, wherein the at least one positive electrode and the at least one negative electrode are arranged on the substrate at a distance from one another of about 1 μm to about 10 mm.

26. The battery of claim 18, wherein the at least one positive electrode and the at least one negative electrode are arranged on the substrate at a distance from one another of about 100 μm and 1 mm.

27. The battery of claim 18, wherein the electrolyte is a gel.

28. The battery of claim 18, wherein the electrolyte is fixed in a felt.

29. The battery of claim 18, wherein the electrolyte is in the form of a layer which substantially completely covers the electrodes.

30. The battery of claim 18, further comprising plastic film which at least partially covers the electrolyte and/or the electrodes.

31. The battery of claim 30, wherein the plastic film, together with the substrate, forms a housing which surrounds the electrolyte and the electrodes and forms a seal.

32. The battery of claim 18, comprising a plurality of positive and negative electrodes arranged in pairs alongside one another on the substrate.

33. The battery of claim 18, wherein the substrate has conductor tracks via which electrodes arranged on the substrate are connected in series and/or in parallel.

34. A method of producing an electrochemical element of claim 18, wherein the electrodes are applied to an endless strip which is used as the substrate and provided continuously with output conductors.

35. The method of claim 34, wherein the electrodes are printed on.
